(19) United States
(12) Patent Application Publication
(10) Pub. No.: US 2024/0262161 A1
(43) Pub. Date: Aug. 8, 2024

(54) TEMPERATURE CONTROL SYSTEM

(71) Applicant: SUBARU CORPORATION, Tokyo (JP)

(72) Inventor: Tomoyuki YAMAMURO, Tokyo (JP)

(21) Appl. No.: 18/415,510

(22) Filed: Jan. 17, 2024

(30) Foreign Application Priority Data
Feb. 3, 2023 (JP) 2023-015587

(51) Int. Cl. B60H 1/00

(52) U.S. Cl. CPC B60H 1/00807; B60H 1/00835

(57) ABSTRACT

A temperature control system includes an air-cooling target unit, an air passage in which the air-cooling target unit is disposed and through which air that exchanges heat with the air-cooling target unit flows, an inside-air intake passage, an outside-air intake passage, an intake opening/closing member, and a control device including at least one processor and at least one memory coupled to the processor. The processor performs a process including: determining whether transition of a temperature of the air-cooling target unit is in a rising trend; performing an intake air determination process of determining which of inside air and outside air is to be introduced into the air passage when the transition of the temperature of the air-cooling target unit is in the rising trend; and refraining from performing the intake air determination process when the transition of the temperature of the air-cooling target unit is not in the rising trend.

### CROSS-REFERENCE TO RELATED APPLICATIONS

The present application claims priority from Japanese Patent Application No. 2023-015587 filed on Feb. 3, 2023, the entire contents of which are hereby incorporated by reference.

### BACKGROUND

The present disclosure relates to a temperature control system.

For example, Japanese Unexamined Patent Application Publication (JP-A) No. 2009-252659 discloses a technique for controlling the temperature of a power supply device mounted on a vehicle. In JP-A No. 2009-252659, when a battery temperature is higher than a threshold value, a cooling capacity of a battery pack is calculated from a vehicle speed and an outside air temperature. In addition, in JP-A No. 2009-252659, in accordance with the calculated cooling capacity, it is selected whether to cool the battery pack by using inside air, which is air inside the vehicle, or outside air, which is air outside the vehicle.

### SUMMARY

An aspect of the disclosure provides a temperature control system. The temperature control system includes an air-cooling target unit, an air passage, an inside-air intake passage, an outside-air intake passage, an intake opening/closing member, and a control device. The air-cooling target unit is configured to be mounted on a vehicle. The air-cooling target unit is configured to generate heat when a current flows the air-cooling target unit, and is configured to be air-cooled. The air passage in which the air-cooling target unit is disposed and through which air that exchanges heat with the air-cooling target unit is to flow. The inside-air intake passage is configured to acquire inside air and to supply the inside air to the air passage, the inside air being air inside the vehicle. The outside-air intake passage is configured to acquire outside air, and to supply the outside air to the air passage, the outside air being air outside the vehicle. The intake opening/closing member is configured to open and close between the air passage and the inside-air intake passage and open and close between the air passage and the outside-air intake passage. The control device includes one or more processors, and one or more memories coupled to the one or more processors. The one or more processors are configured to perform a process comprising: determining whether transition of a temperature of the air-cooling target unit is in a rising trend; performing an intake air determination process of determining which of the inside air and the outside air is to be introduced into the air passage when it is determined that the transition of the temperature of the air-cooling target unit is in the rising trend; and refraining from performing the intake air determination process when it is determined that the transition of the temperature of the air-cooling target unit is not in the rising trend.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic diagram illustrating a configuration of a vehicle to which a temperature control system according to an embodiment is applied;

FIG. 2 is a flowchart illustrating an operation flow of a temperature controller; and

FIG. 3 is a flowchart illustrating a flow of an intake air determination process.

### DETAILED DESCRIPTION

However, even when the battery temperature is higher than the threshold value, unless the temperature of an air-cooling target unit, which is a unit to be air-cooled, such as the power supply device, rises with time, it is estimated that the air-cooling of the air-cooling target unit by using the current air is functioning. In this case, for example, if the determination as to whether the air-cooling target unit is to be air-cooled by using the inside air or the outside air is always performed in a state where the battery temperature is higher than the threshold value, a processing load for performing such determination increases.

Therefore, it is desirable to provide a temperature control system capable of appropriately air-cool the air-cooling target unit.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

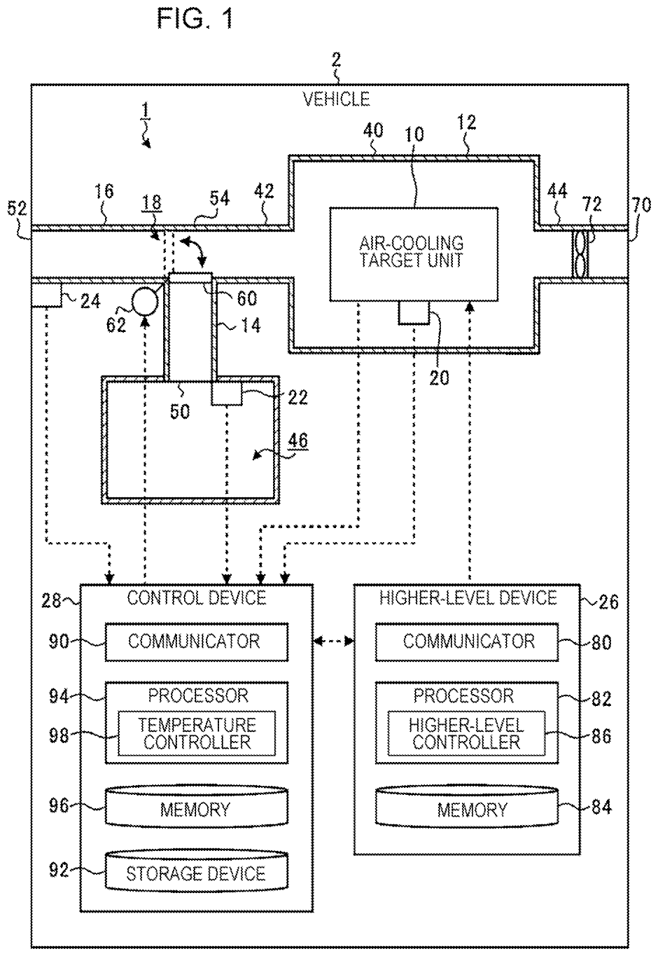

FIG. 1 is a schematic diagram illustrating a configuration of a vehicle 2 to which a temperature control system 1 according to the embodiment is applied. The vehicle 2 is, for example, an electric vehicle including a motor as a drive source. The vehicle 2 may be a hybrid electric vehicle including a motor and an engine as drive sources.

The vehicle 2 includes an air-cooling target unit 10, an air passage 12, an inside-air intake passage 14, an outside-air intake passage 16, an intake opening/closing member 18, a unit temperature sensor 20, an inside-air temperature sensor 22, an outside-air temperature sensor 24, a higher-level device 26, and a control device 28.

The air-cooling target unit 10 is mounted on the vehicle 2 and generates heat when a current flows therethrough, and to be air-cooled.

The air-cooling target unit 10 is, for example, an inverter that uses electric power supplied from high-voltage system wiring of the vehicle 2 to drive a motor for traveling, a direct current-direct current (DC-DC) converter that supplies the electric power from the high-voltage system wiring to low-voltage system wiring, a battery that supplies the electric power to the high-voltage system wiring, or the like. As described above, since electrical equipment coupled to the high-voltage system wiring generates a large amount of heat when a current flows therethrough, it is preferable to actively cool the electrical equipment in order to suppress an increase in temperature due to heat generation. The air-cooling target unit 10 is electrical equipment to be cooled as described above, and is cooled by using air.

Although FIG. 1 illustrates an example in which the single air-cooling target unit 10 is provided, the number of air-cooling target units 10 is not limited to one, and air-cooling target units 10 may be provided.

The air-cooling target unit 10 is disposed in the air passage 12. The air passage 12 is a passage through which air that exchanges heat with the air-cooling target unit 10 flows. In more detail, the air passage 12 is divided into a main passage 40, a common intake passage 42, and an exhaust passage 44.

The air-cooling target unit 10 is disposed in the main passage 40. The common intake passage 42 and the exhaust passage 44 communicate with the main passage 40. The common intake passage 42 is located upstream of the flow of the air flowing through the air passage 12 with respect to the main passage 40. The exhaust passage 44 is located downstream of the flow of the air flowing through the air passage 12 with respect to the main passage 40.

The inside-air intake passage 14 communicates with the common intake passage 42. The inside-air intake passage 14 acquires inside air, which is air in an interior 46 of the vehicle 2, and supplies the inside air to the air passage 12. The inside air may be air in a cabin of the vehicle 2 configured to accommodate one or more occupants, air in a luggage room of the vehicle 2 configured to store luggage, or the both.

At an end of the inside-air intake passage 14 opposite to the common intake passage 42, an inside-air acquisition port 50 is formed. The inside-air acquisition port 50 is open to the interior 46 of the vehicle 2. For example, the inside-air acquisition port 50 is below a rear seat of the vehicle 2. Note that the inside-air acquisition port 50 is not limited to that disposed at the illustrated position and may be disposed at any position at which the inside air can be appropriately acquired.

The outside-air intake passage 16 communicates with the common intake passage 42. The outside-air intake passage 16 acquires outside air, which is air outside the vehicle 2, and supplies the outside air to the air passage 12.

At an end of the outside-air intake passage 16 opposite to the common intake passage 42, an outside-air acquisition port 52 is formed. The outside-air acquisition port 52 is open to the outside of the vehicle 2. For example, the outside-air acquisition port 52 is near a rear wheel in a lower portion of the vehicle 2. Note that the outside-air acquisition port 52 is not limited to that disposed at the illustrated position and may be disposed at any position at which the outside air can be appropriately acquired. In addition, the outside-air acquisition port 52 is open toward the rear of the vehicle 2 in order to suppress mixing of foreign matter. Note that the opening direction of the outside-air acquisition port 52 is not limited to the rear of the vehicle 2 and may be the front of the vehicle 2, for example.

The intake opening/closing member 18 is provided in a merging portion 54 where the inside-air intake passage 14 and the outside-air intake passage 16 are coupled to the common intake passage 42. The intake opening/closing member 18 is configured to be capable of exclusively opening and closing between the air passage 12 and the inside-air intake passage 14 and between the air passage 12 and the outside-air intake passage 16.

In more detail, the intake opening/closing member 18 includes a valve body 60 and an actuator 62. The valve body 60 is formed in a plate shape, for example.

The valve body 60 is configured to be movable between an end of the inside-air intake passage 14 on the common intake passage 42 side and an end of the outside-air intake passage 16 on the common intake passage 42 side. In other words, the valve body 60 is configured to be capable of exclusively switching between an inside-air selected state in which the inside-air intake passage 14 is open and the outside-air intake passage 16 is closed, and an outside-air selected state in which the inside-air intake passage 14 is closed and the outside-air intake passage 16 is open. In FIG. 1, the outside-air selected state is illustrated by the position of the valve body 60 illustrated by a solid line, and the inside-air selected state is illustrated by the position of the valve body 60 illustrated by a broken line. The actuator 62 drives the valve body 60 under the control of the control device 28.

At an end of the exhaust passage 44 opposite to the main passage 40, an exhaust port 70 is formed. The exhaust port 70 is open at least to the outside of the vehicle 2. For example, the exhaust port 70 is in a trunk of the vehicle 2. Note that the exhaust port 70 is not limited to that disposed at the illustrated position and may be disposed at any position at which the air having flowed through the air passage 12 can be appropriately discharged to the outside of the vehicle 2.

The exhaust passage 44 is provided with a fan 72. The fan 72 causes the air in the air passage 12 to flow.

In more detail, when the intake opening/closing member 18 is in the inside-air selected state, the fan 72 takes the inside air into the inside-air intake passage 14 through the inside-air acquisition port 50. Then, the fan 72 causes the taken inside air to flow to the inside-air intake passage 14, the common intake passage 42, the main passage 40, and the exhaust passage 44 in this order and discharges the inside air from the exhaust port 70. Thus, the air-cooling target unit 10 is cooled by using the inside air flowing through the air passage 12.

In addition, when the intake opening/closing member 18 is in the outside-air selected state, the fan 72 takes the outside air into the outside-air intake passage 16 through the outside-air acquisition port 52. Then, the fan 72 causes the taken outside air to flow to the outside-air intake passage 16, the common intake passage 42, the main passage 40, and the exhaust passage 44 in this order and discharges the outside air from the exhaust port 70. Thus, the air-cooling target unit 10 is cooled by using the outside air flowing through the air passage 12.

Note that the fan 72 is not limited to that provided in the exhaust passage 44 and may be provided in the common intake passage 42 or in the main passage 40. Alternatively, the fan 72 may be omitted, and the inside air and the outside air may be taken into the air passage 12 by natural flow of the inside air and the outside air.

The unit temperature sensor 20 is provided for the air-cooling target unit 10 and detects the temperature of the air-cooling target unit 10. If the air-cooling target units 10 are provided, the unit temperature sensor 20 is provided for each of the air-cooling target units 10.

For example, the inside-air temperature sensor 22 is disposed, around the inside-air acquisition port 50 in the interior 46 of the vehicle 2 and detects the temperature of the inside air. Note that the inside-air temperature sensor 22 is not limited to that disposed around the inside-air acquisition port 50 and may be disposed at any position at which the temperature of the inside air in the interior 46 of the vehicle 2 can be appropriately detected.

For example, the outside-air temperature sensor 24 is exposed to the outside of the vehicle 2, is disposed around the outside-air acquisition port 52, and detects the temperature of the outside air. Note that the outside-air temperature sensor 24 is not limited to that disposed around the outside-air acquisition port 52 and may be disposed at any position at which the temperature of the outside air can be appropriately detected.

The higher-level device 26 is, for example, an electronic control unit that integrally controls control units. The higher-level device 26 includes a communicator 80, one or more processors 82, and one or more memories 84 coupled to the one or more processors 82.

The communicator 80 establishes communication with devices and control devices mounted on the vehicle 2. For example, the higher-level device 26 can communicate with the air-cooling target unit 10 through the communicator 80 to control the operation of the air-cooling target unit 10. The higher-level device 26 can also communicate with the control device 28 through the communicator 80.

The one or more memories 84 include a read-only memory (ROM) in which programs and the like are stored, and a random access memory (RAM) as a work area. The one or more processors 82 serve as a higher-level controller 86 that controls the entirety of the higher-level device 26 in cooperation with the programs included in the one or more memories 84.

The higher-level controller 86 transmits, to the air-cooling target unit 10, an output instruction signal, which is a signal for causing the air-cooling target unit 10 to perform electrical output. The higher-level controller 86 transmits the output instruction signal to the air-cooling target unit 10 when the air-cooling target unit 10 is caused to perform the output, and does not transmit the output instruction signal when the air-cooling target unit 10 is not caused to perform the output. That is, although the output instruction signal is not transmitted when the output of the air-cooling target unit 10 is zero, the output instruction signal is transmitted when the output is to be performed from the air-cooling target unit 10 even if the output value is small.

For example, when the air-cooling target unit 10 is an inverter, the higher-level controller 86 transmits, to the inverter, the output instruction signal indicating a control value of a current or a voltage to be supplied from the inverter to the motor. The inverter supplies the current or the voltage to the motor in accordance with the output instruction signal received from the higher-level device 26. When the vehicle 2 is traveling by the motor for traveling, the output instruction signal is transmitted from the higher-level device 26 to the inverter. On the other hand, when the vehicle 2 is stopped or traveling by the engine, the output instruction signal is not transmitted from the higher-level device 26 to the inverter.

For example, when the air-cooling target unit 10 is a DC-DC converter, the higher-level controller 86 transmits, to the DC-DC converter, the output instruction signal indicating a control value of a current to be supplied from the DC-DC converter to the low-voltage system wiring. The DC-DC converter supplies the current to the low-voltage system wiring in accordance with the output instruction signal received from the higher-level device 26. For example, when power consumption of the low-voltage system wiring is large, such as a case where an air conditioner is in operation, the output instruction signal is transmitted from the higher-level device 26 to the DC-DC converter. On the other hand, for example, when power consumption of the low-voltage system wiring is small, such as a case where an air conditioner is not in operation, the output instruction signal is not transmitted from the higher-level device 26 to the DC-DC converter.

The control device 28 includes a communicator 90, a storage device 92, one or more processors 94, and one or more memories 96 coupled to the one or more processors 94.

The communicator 90 establishes communication with devices and control devices mounted on the vehicle 2. For example, the control device 28 may communicate with the air-cooling target unit 10 through the communicator 90 to acquire any information of the air-cooling target unit 10. The control device 28 can also communicate with the higher-level device 26 through the communicator 90.

The storage device 92 is constituted by a non-volatile storage element. The non-volatile storage element may include an electrically readable and writable non-volatile storage element such as a flash memory, for example.

The one or more memories 96 include a ROM in which programs and the like are stored, and a RAM as a work area. The one or more processors 94 serve as a temperature controller 98 that implements an operation of the temperature control system 1 in cooperation with the programs included in the one or more memories 96.

The temperature controller 98 determines whether the output instruction signal has been transmitted from the higher-level device 26 to the air-cooling target unit 10.

For example, the temperature controller 98 may periodically communicate with the air-cooling target unit 10 and acquire, from the air-cooling target unit 10, information indicating whether the air-cooling target unit 10 has received the output instruction signal from the higher-level device 26. Alternatively, the temperature controller 98 may periodically communicate with the higher-level device 26 and acquire, from the higher-level device 26, information indicating whether the higher-level device 26 has transmitted the output instruction signal to the air-cooling target unit 10. Further alternatively, the higher-level device 26 may transmit the output instruction signal to the air-cooling target unit 10 and transmit, to the control device 28, information indicating that the output instruction signal has been transmitted. In this case, the temperature controller 98 may recognize that the output instruction signal has been transmitted when the temperature controller 98 receives, from the higher-level device 26, information indicating that the higher-level device 26 has transmitted the output instruction signal to the air-cooling target unit 10.

In addition, the temperature controller 98 acquires the temperature of the air-cooling target unit 10 detected by the unit temperature sensor 20 and determines whether the transition of the temperature of the air-cooling target unit 10 is in a rising trend. If there are air-cooling target units 10, the temperature controller 98 determines that the transition of the temperature of the air-cooling target units 10 is in the rising trend when the transition of the temperature of any one or more air-cooling target units 10 among the air-cooling target units 10 is in the rising trend. The temperature controller 98 may use a temperature obtained by performing low-pass filter processing on the temperature acquired from the unit temperature sensor 20 for the determination of the rising trend.

Here, the fact that the transition of the temperature is in the rising trend means that even if the temperature fluctuates up and down in a short period of time, the temperature tends to rise in an intermediate period of time or a long period of time. For example, the temperature controller 98 may determine that the rising trend is exhibited when the value of the temperature after the low-pass filter processing continues to rise in a predetermined cycle. The predetermined cycle is set to be longer than a sampling cycle at which the temperature is acquired from the unit temperature sensor 20.

In more detail, the temperature controller 98 repeatedly acquires the temperature of the air-cooling target unit 10 at predetermined time intervals. The temperature controller 98 uses the temperature of the air-cooling target unit 10 for the most recent predetermined number of times, including the temperature of the air-cooling target unit 10 at the current control timing, as samples for determining the rising trend. The predetermined time interval is set to, for example, one second or the like, but can be set to any interval in consideration of the speed of the temperature change of the air-cooling target unit 10. The predetermined number of times is set to, for example, ten or the like, but can be set to any number by which the rising trend can be appropriately determined.

For example, the temperature controller 98 derives a moving average of the temperature of the air-cooling target unit 10 for the most recent predetermined number of times. In an example in which the predetermined number of times is ten, a moving average of the temperature for a total of ten times including the temperature at the current timing and the temperature for the previous nine times close to the current timing is derived. When the moving average derived at the current control timing is larger than the moving average derived at the previous control timing, the temperature controller 98 may determine that the transition of the temperature of the air-cooling target unit 10 is in the rising trend.

In addition, the temperature controller 98 may focus on a sample among samples for the most recent predetermined number of times and derive whether the value of the focused sample is larger than the value of the previous sample for each of the samples for the predetermined number of times. When the number of samples for which the values are larger than the values of the previous samples is larger than a predetermined comparison value that is larger than or equal to half the predetermined number of times, the temperature controller 98 may determine that the transition of the temperature of the air-cooling target unit 10 is in the rising trend.

Note that a specific method of determining whether the rising trend is exhibited is not limited to the illustrated method, and any method capable of appropriately determining the rising trend can be adopted.

When the temperature controller 98 determines that the output instruction signal has been transmitted from the higher-level device 26 to the air-cooling target unit 10 and determines that the transition of the temperature of the air-cooling target unit 10 is in the rising trend, the temperature controller 98 performs an intake air determination process. The intake air determination process is a process of determining which of the inside air and the outside air is to be introduced into the air passage 12.

The temperature controller 98 may perform the intake air determination process when it is determined that the transition of the temperature of the air-cooling target unit 10 is in the rising trend regardless of whether the output instruction signal has been transmitted from the higher-level device 26 to the air-cooling target unit 10.

In the intake air determination process, the temperature controller 98 derives a temperature difference obtained by subtracting the temperature of the inside air from the temperature of the outside air. When the temperature difference is larger than a predetermined first threshold value larger than zero, the temperature controller 98 brings the intake opening/closing member 18 into the inside-air selected state to introduce the inside air into the air passage 12. In other words, in this case, the temperature controller 98 controls the intake opening/closing member 18 such that the inside air is introduced into the air passage 12 and the outside air is not introduced into the air passage 12.

The predetermined first threshold value larger than zero is set to any value by which it is possible to specify the generated temperature difference as having a level for which it is useful to switch the air introduced into the air passage 12 from the outside air to the inside air. In addition, the first threshold value may be set in consideration of measurement accuracy due to manufacturing variations of the inside-air temperature sensor 22 and the outside-air temperature sensor 24.

When the temperature difference is smaller than a predetermined second threshold value smaller than zero, the temperature controller 98 brings the intake opening/closing member 18 into the outside-air selected state to introduce the outside air into the air passage 12. In other words, in this case, the temperature controller 98 controls the intake opening/closing member 18 such that the outside air is introduced into the air passage 12 and the inside air is not introduced into the air passage 12.

The predetermined second threshold value smaller than zero is set to any value by which it is possible to distinguish the generated temperature difference as having a level for which it is useful to switch the air introduced into the air passage 12 from the inside air to the outside air. In addition, the second threshold value may be set in consideration of measurement accuracy due to manufacturing variations of the inside-air temperature sensor 22 and the outside-air temperature sensor 24.

The first threshold value and the second threshold value may be set such that the absolute value of the first threshold value and the absolute value of the second threshold value are the same value, or the first threshold value and the second threshold value may be set such that the absolute value of the first threshold value and the absolute value of the second threshold value are different values.

When the temperature difference is smaller than or equal to the first threshold value and larger than or equal to the second threshold value, the temperature controller 98 maintains the intake opening/closing member 18 in the current state. That is, the inside-air selected state is maintained when the current state is the inside-air selected state, and the outside-air selected state is maintained when the current state is the outside-air selected state.

When the temperature difference is smaller than or equal to the first threshold value and larger than or equal to the second threshold value, the temperature of the outside air and the temperature of the inside air are approximately the same temperature. Accordingly, even if the air-cooling target unit 10 is cooled by using any one of the outside air and the inside air, a large difference does not occur in the cooling effect. Therefore, in this case, the intake opening/closing member 18 is maintained in the current state, that is, the switching between the outside-air selected state and the inside-air selected state is not performed. Accordingly, it is possible to suppress the state of the intake opening/closing member 18 from being unnecessarily frequently switched while suppressing a decrease in the cooling effect of the air-cooling target unit 10. As a result, it is possible to suppress power consumption for switching the state of the intake opening/closing member 18.

When it is determined that the output instruction signal has not been transmitted from the higher-level device 26 to the air-cooling target unit 10, the temperature controller 98 does not perform the intake air determination process.

When the output instruction signal has not been transmitted, the air-cooling target unit 10 does not perform the electrical output. Therefore, it is estimated that the heat generation of the air-cooling target unit 10 does not increase and the temperature of the air-cooling target unit 10 does not rise. That is, when it is determined that the output instruction signal has not been transmitted, since it is possible to suppress a rise in the temperature of the air-cooling target unit 10 even if the current air-cooling mode of the air-cooling target unit 10 is maintained, the intake air determination process is not performed. Accordingly, it is possible to reduce the processing load of the intake air determination process as compared to a mode in which the intake air determination process is performed every time.

When it is determined that the transition of the temperature of the air-cooling target unit 10 is not in the rising trend, the temperature controller 98 does not perform the intake air determination process.

When the transition of the temperature of the air-cooling target unit 10 is not in the rising trend, since it is possible to suppress a rise in the temperature of the air-cooling target unit 10 even if the current air-cooling mode of the air-cooling target unit 10 is maintained, the intake air determination process is not performed. Accordingly, it is possible to reduce the processing load of the intake air determination process as compared to a mode in which the intake air determination process is performed every time.

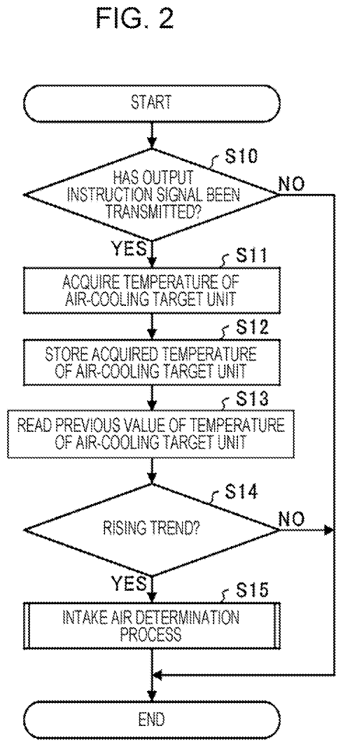

FIG. 2 is a flowchart illustrating an operation flow of the temperature controller 98. The temperature controller 98 repeatedly executes a series of processes in FIG. 2 at every predetermined interruption timing. The predetermined interruption timing is at predetermined time intervals. The predetermined time interval is set to, for example, one second or the like, but may be set to any interval in consideration of the speed of the temperature change of the air-cooling target unit 10.

At the predetermined interruption timing, the temperature controller 98 determines whether the output instruction signal has been transmitted from the higher-level device 26 to the air-cooling target unit 10 (S10).

When it is determined that the output instruction signal has not been transmitted from the higher-level device 26 to the air-cooling target unit 10 (NO in S10), the temperature controller 98 ends the series of processes in FIG. 2. In this case, the intake air determination process is not performed.

When it is determined that the output instruction signal has been transmitted from the higher-level device 26 to the air-cooling target unit 10 (YES in S10), the temperature controller 98 acquires the temperature of the air-cooling target unit 10 detected by the unit temperature sensor 20 (S11). The temperature controller 98 stores the acquired temperature of the air-cooling target unit 10 in the storage device 92 in association with the acquisition timing (S12).

The temperature controller 98 reads a previous value of the temperature of the air-cooling target unit 10 from the storage device 92 (S13). For example, the temperature controller 98 reads the temperature of the air-cooling target unit 10 from the current control timing to the predetermined number of times before.

The temperature controller 98 determines whether the transition of the temperature of the air-cooling target unit 10 is in the rising trend, based on the temperature of the air-cooling target unit 10 at the current control timing acquired in step S11 and the temperature of the air-cooling target unit 10 read in step S13 (S14).

For example, the temperature controller 98 derives the moving average from the temperature of the air-cooling target unit 10 acquired at the current control timing and the read previous value of the temperature of the air-cooling target unit 10. When the moving average derived at the current timing is larger than the moving average derived at the previous timing, the temperature controller 98 determines that the transition of the temperature of the air-cooling target unit 10 is in the rising trend.

When it is determined that the transition of the temperature of the air-cooling target unit 10 is in the rising trend (YES in S14), the temperature controller 98 performs the intake air determination process (S15) and ends the series of processes in FIG. 2. The intake air determination process (S15) will be described in detail later.

When it is determined that the transition of the temperature of the air-cooling target unit 10 is not in the rising trend (NO in S14), the temperature controller 98 ends the series of processes in FIG. 2. In this case, the intake air determination process is not performed.

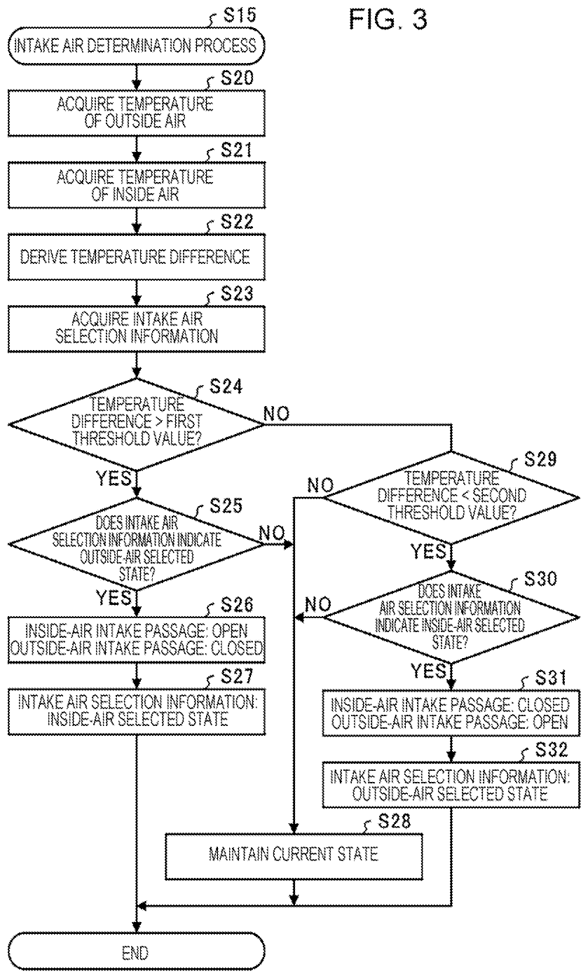

FIG. 3 is a flowchart illustrating a flow of the intake air determination process (S15). Upon starting of the intake air determination process (S15), the temperature controller 98 acquires the temperature of the outside air detected by the outside-air temperature sensor 24 (S20). The temperature controller 98 acquires the temperature of the inside air detected by the inside-air temperature sensor 22 (S21). The temperature controller 98 subtracts the acquired temperature of the inside air from the acquired temperature of the outside air to derive the temperature difference (S22).

Subsequently, the temperature controller 98 acquires current intake air selection information (S23). Here, the intake air selection information is information indicating whether the current state of the intake opening/closing member 18 is the inside-air selected state or the outside-air selected state. The current intake air selection information is stored in the storage device 92. For example, the intake air selection information may be stored in a flag format in which the inside-air selected state is “1” and the outside-air selected state is “0”. The temperature controller 98 can acquire the current intake air selection information by reading the intake air selection information stored in the storage device 92.

Subsequently, the temperature controller 98 determines whether the temperature difference derived in step S22 is larger than the predetermined first threshold value larger than zero (S24).

When it is determined that the temperature difference is larger than the first threshold value (YES in S24), the temperature controller 98 determines whether the current intake air selection information acquired in step S23 indicates the outside-air selected state (S25).

When it is determined that the current intake air selection information indicates the outside-air selected state (YES in S25), the temperature controller 98 controls the intake opening/closing member 18 such that the inside-air intake passage 14 is open and the outside-air intake passage 16 is closed (S26). That is, since the temperature of the outside air is relatively higher than the temperature of the inside air and the intake opening/closing member 18 is in the outside-air selected state, the temperature controller 98 switches the intake opening/closing member 18 to the inside-air selected state so as to introduce the inside air having a relatively low temperature into the air passage 12. Then, the temperature controller 98 updates the intake air selection information to the inside-air selected state and stores it in the storage device 92 (S27), and ends the intake air determination process (S15).

On the other hand, when it is determined that the current intake air selection information does not indicate the outside-air selected state, that is, the current intake air selection information indicates the inside-air selected state (NO in S25), the temperature controller 98 maintains the intake opening/closing member 18 in the current state (S28), and ends the intake air determination process (S15). In step S28, the temperature controller 98 does not substantially perform any process on the intake opening/closing member 18. That is, although the temperature of the outside air is relatively higher than the temperature of the inside air, since the intake opening/closing member 18 is in the inside-air selected state, the inside air having a relatively low temperature is introduced into the air passage 12. Thus, the temperature controller 98 maintains the intake opening/closing member 18 in the inside-air selected state. The current details of the intake air selection information are maintained.

When it is determined in step S24 that the temperature difference is smaller than or equal to the first threshold value (NO in S24), the temperature controller 98 determines whether the temperature difference is smaller than the predetermined second threshold value smaller than zero (S29).

When it is determined that the temperature difference is smaller than the second threshold value (YES in S29), the temperature controller 98 determines whether the current intake air selection information indicates the inside-air selected state (S30).

When it is determined that the current intake air selection information indicates the inside-air selected state (YES in S30), the temperature controller 98 controls the intake opening/closing member 18 such that the inside-air intake passage 14 is closed and the outside-air intake passage 16 is open (S31). That is, since the temperature of the outside air is relatively lower than the temperature of the inside air and the intake opening/closing member 18 is in the inside-air selected state, the temperature controller 98 switches the intake opening/closing member 18 to the outside-air selected state so as to introduce the outside air having a relatively low temperature into the air passage 12. Then, the temperature controller 98 updates the intake air selection information to the outside-air selected state and stores it in the storage device 92 (S32), and ends the intake air determination process (S15).

On the other hand, when it is determined that the current intake air selection information does not indicate the inside-air selected state, that is, the current intake air selection information indicates the outside-air selected state (NO in S30), the temperature controller 98 maintains the intake opening/closing member 18 in the current state (S28), and ends the intake air determination process (S15). That is, although the temperature of the outside air is relatively lower than the temperature of the inside air, since the intake opening/closing member 18 is in the outside-air selected state, the outside air having a relatively low temperature is introduced into the air passage 12. Thus, the temperature controller 98 maintains the intake opening/closing member 18 in the outside-air selected state. The current details of the intake air selection information are maintained.

When it is determined in step S29 that the temperature difference is larger than or equal to the second threshold value (NO in S29), the temperature controller 98 maintains the intake opening/closing member 18 in the current state (S28), and ends the intake air determination process (S15). That is, since the temperature of the outside air and the temperature of the inside air are approximately the same temperature, even if the air-cooling target unit 10 is cooled by using any one of the outside air and the inside air, a large difference does not occur in the cooling effect. Thus, the temperature controller 98 maintains the intake opening/closing member 18 in the current state. The current details of the intake air selection information are maintained.

As described above, in the temperature control system 1 of the present embodiment, it is determined whether the transition of the temperature of the air-cooling target unit 10 is in the rising trend. In the temperature control system 1 of the present embodiment, when it is determined that the transition of the temperature of the air-cooling target unit 10 is in the rising trend, the intake air determination process of determining which of the inside air and the outside air is to be introduced into the air passage 12 is performed. In the temperature control system 1 of the present embodiment, when it is determined that the transition of the temperature of the air-cooling target unit 10 is not in the rising trend, the intake air determination process is not performed.

Accordingly, in the temperature control system 1 of the present embodiment, when the transition of the temperature of the air-cooling target unit 10 is in the rising trend, appropriate air of the outside air and the inside air is introduced into the air passage 12, and the air-cooling target unit 10 can be effectively cooled. In addition, in the temperature control system 1 of the present embodiment, when the transition of the temperature of the air-cooling target unit 10 is not in the rising trend, the intake air determination process is not performed. Accordingly, it is possible to reduce the processing load of the intake air determination process as compared to a mode in which the intake air determination process is performed every time.

Therefore, according to the temperature control system 1 of the present embodiment, it is possible to appropriately air-cool the air-cooling target unit 10.

In addition, in the temperature control system 1 of the present embodiment, it is determined whether the output instruction signal has been transmitted from the higher-level device to the air-cooling target unit. In the temperature control system 1 of the present embodiment, when it is determined that the output instruction signal has been transmitted from the higher-level device to the air-cooling target unit and that the transition of the temperature of the air-cooling target unit is in the rising trend, the intake air determination process is performed. In the temperature control system 1 of the present embodiment, when it is determined that the output instruction signal has not been transmitted from the higher-level device to the air-cooling target unit, the intake air determination process is not performed.

Accordingly, in the temperature control system 1 of the present embodiment, when the output instruction signal has been transmitted and the transition of the temperature of the air-cooling target unit 10 is in the rising trend, appropriate air of the outside air and the inside air is introduced into the air passage 12, and the air-cooling target unit 10 can be effectively cooled. In the temperature control system 1 of the present embodiment, when the output instruction signal has not been transmitted, the intake air determination process is not performed. Accordingly, it is possible to reduce the processing load of the intake air determination process as compared to a mode in which the intake air determination process is performed every time.

Furthermore, in the temperature control system 1 of the present embodiment, when the temperature difference obtained by subtracting the temperature of the inside air from the temperature of the outside air is larger than the predetermined first threshold value larger than zero, the intake opening/closing member 18 is controlled so as to introduce the inside air into the air passage 12 and not to introduce the outside air into the air passage 12. In the temperature control system 1 of the present embodiment, when the temperature difference is smaller than the predetermined second threshold value smaller than zero, the intake opening/closing member 18 is controlled so as to introduce the outside air into the air passage 12 and not to introduce the inside air into the air passage 12. In the temperature control system 1 of the present embodiment, when the temperature difference is smaller than or equal to the first threshold value and larger than or equal to the second threshold value, the intake opening/closing member 18 is maintained in the current state.

Accordingly, in the temperature control system 1 of the present embodiment, when the temperature difference is larger than the first threshold value and when the temperature difference is larger than the second threshold value, appropriate air of the outside air and the inside air is introduced into the air passage 12, and the air-cooling target unit 10 can be effectively cooled. In the temperature control system 1 of the present embodiment, when the temperature difference is smaller than or equal to the first threshold value and is larger than or equal to the second threshold value, the intake air determination process is not performed. Accordingly, it is possible to reduce the processing load of the intake air determination process as compared to a mode in which the intake air determination process is performed every time.

Although the embodiment of the present disclosure has been described above with reference to the accompanying drawings, the present disclosure is not limited to the embodiment. It is clear that those skilled in the art can conceive of various modifications or corrections within the scope described in the claims. It is to be understood that these are naturally included in the technical scope of the disclosure.

For example, in the above-described embodiment, the control device 28 separate from the higher-level device 26 includes the functions of the temperature controller 98 that implements the operation of the temperature control system 1. However, the functions of the temperature controller 98 may also be included in another device, not limited to the control device 28, such as the higher-level device 26 or another control device 28 mounted on the vehicle 2. In addition, the functions of the temperature controller 98 are not limited to the functions integrated in the single control device 28, and may be distributed to control devices.

According to the present disclosure, it is possible to appropriately air-cool the air-cooling target unit.

The temperature controller 98 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the temperature controller 98. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. A temperature control system comprising:
an air-cooling target unit configured to be mounted on a vehicle, the air-cooling target unit being configured to generate heat when a current flows the air-cooling target unit, and being configured to be air-cooled;
an air passage in which the air-cooling target unit is disposed and through which air that exchanges heat with the air-cooling target unit is to flow;
an inside-air intake passage configured to acquire inside air and to supply the inside air to the air passage, the inside air being air inside the vehicle;
an outside-air intake passage configured to acquire outside air, and to supply the outside air to the air passage, the outside air being air outside the vehicle;
an intake opening/closing member configured to open and close between the air passage and the inside-air intake passage and open and close between the air passage and the outside-air intake passage; and
a control device, wherein
the control device comprises:
one or more processors; and
one or more memories coupled to the one or more processors, and
the one or more processors are configured to perform a process comprising:
determining whether transition of a temperature of the air-cooling target unit is in a rising trend;
performing an intake air determination process of determining which of the inside air and the outside air is to be introduced into the air passage when it is determined that the transition of the temperature of the air-cooling target unit is in the rising trend; and
refraining from performing the intake air determination process when it is determined that the transition of the temperature of the air-cooling target unit is not in the rising trend.

2. The temperature control system according to claim 1, further comprising a higher-level device configured to transmit an output instruction signal to the air-cooling target unit, the output instruction signal being a signal for causing the air-cooling target unit to perform electrical output, wherein
the process includes:
determining whether the output instruction signal has been transmitted from the higher-level device to the air-cooling target unit;
performing the intake air determination process when it is determined that the output instruction signal has been transmitted from the higher-level device to the air-cooling target unit and that the transition of the temperature of the air-cooling target unit is in the rising trend; and
refraining from performing the intake air determination process when it is determined that the output instruction signal has not been transmitted from the higher-level device to the air-cooling target unit.

3. The temperature control system according to claim 1, wherein the intake air determination process includes:
controlling the intake opening/closing member so as to introduce the inside air into the air passage and not to introduce the outside air into the air passage when a temperature difference obtained by subtracting the temperature of the inside air from the temperature of the outside air is larger than a predetermined first threshold value larger than zero;
controlling the intake opening/closing member so as to introduce the outside air into the air passage and not to introduce the inside air into the air passage when the temperature difference is smaller than a predetermined second threshold value smaller than zero; and
maintaining the intake opening/closing member in a current state when the temperature difference is smaller than or equal to the first threshold value and larger than or equal to the second threshold value.

4. The temperature control system according to claim 2, wherein the intake air determination process includes:
controlling the intake opening/closing member so as to introduce the inside air into the air passage and not to introduce the outside air into the air passage when a temperature difference obtained by subtracting the temperature of the inside air from the temperature of the outside air is larger than a predetermined first threshold value larger than zero;
controlling the intake opening/closing member so as to introduce the outside air into the air passage and not to introduce the inside air into the air passage when the temperature difference is smaller than a predetermined second threshold value smaller than zero; and
maintaining the intake opening/closing member in a current state when the temperature difference is smaller than or equal to the first threshold value and larger than or equal to the second threshold value.
